(19) United States
(12) Patent Application Publication
(10) Pub. No.: US 2010/0239320 A1
(43) Pub. Date: Sep. 23, 2010

(54) COROTRON DEVICE FOR AN ELEMENT MOVING VIA A GUIDE UNIT, IN PARTICULAR IN AN ELECTROGRAPHIC PRINTING APPARATUS

(76) Inventors: Florian Eder, Abensberg (DE); Johannes Thanner, Muenchen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/727,457

(22) Filed: Mar. 19, 2010

(30) Foreign Application Priority Data
Mar. 19, 2009 (DE) 10 2009 013 972.9

(51) Int. Cl. G03G 15/02; H01T 19/04

(52) U.S. Cl. 399/170; 250/325

(57) ABSTRACT

In a corotron device system, a moving element moves via a guide unit. A corotron having a corotron element and a corotron shield is provided. The corotron element is arranged relative to the moving element such that a distance from, and a parallel position of, the corotron element relative to the moving element substantially do not change.

### BACKGROUND

Corotrons are frequently used in electrographic printing apparatuses in order to generate an electrical field with which photoconductor elements, transfer elements or recording media (for example) have their charges reversed.

As an example, from US 2008/0205920 A1 an electrographic printing apparatus is known with which a printing substrate is printed simultaneously on both sides. The toner images are generated in the same manner in the upper printing group and lower printing group and are transfer-printed onto the printing substrate in the transfer printing station. In order to be able to simultaneously transfer-print the toner images onto the printing substrate, the toner images on a transfer belt must have their charges reversed. For this a corotron made of a corotron shield and a corotron wire is used that is arranged adjacent to a roller around which the belt is deflected. Refer to US 2008/0205920 A1 for details and US 2008/0205920 A1 incorporated herein by reference.

The efficiency of the charge reversal depends on, among other things, the charge reversal current. This is directed from the corotron via the ionized air to the transfer belt, where it reverses the charge of the toner image, and finally discharges via the roller. The distance between the corotron and the roller is decisive for the voltage at the corotron shield and the roller.

Since the distance between the corotron and the roller has an effect on the print quality, it is important that the distance between corotron and roller is maintained.

### SUMMARY

An object is to specify a corotron device in which the problems indicated above are avoided. It is thereby to be noted that it should be possible to move the corotron away from the roller, for example, in order to be able to exchange the moving element (for example a belt) and in order to be able to exchange the corotron wire of the corotron.

In a corotron device system, a moving element moves via a guide unit. A corotron having a corotron element and a corotron shield is provided. The corotron element is arranged relative to the moving element such that a distance from, and a parallel position of, the corotron element relative to the moving element substantially do not change.

### BRIEF DESCRIPTION OF THE DRAWINGS

FIG. 1 is a view of the corotron device;

FIG. 2 shows the corotron device when the corotron unit is pivoted out;

FIG. 3 is a section through the corotron device at the point A-A according to FIG. 1;

FIG. 4 is a section through the corotron device at the point B-B according to FIG. 1;

FIG. 5 is a section through the corotron in a second embodiment of the invention;

FIG. 6 is a section through the corotron in a third embodiment of the invention;

FIG. 7 is a view of the pivot arrangement in the pivoted-towards state; and

FIG. 8 is a view of the pivot arrangement in the pivoted-away state.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The preferred embodiments are described in the following in connection with a corotron device with which a belt (for example a transfer belt in an electrographic printing apparatus corresponding to US 2008/0205920 A1) has its charge reversed, and wherein the belt is directed via a roller. However, the preferred embodiments are not limited to this example; rather, it can be used anywhere a corotron interacts with a moving element. The moving element can be a belt, and the guide unit for the moving element can be a roller.

The corotron device has a corotron unit and a pivot arrangement for the corotron unit. The belt can have its charge reversed with the corotron unit; and the corotron unit can be pivoted towards the belt or away therefrom with the pivot arrangement.

For a belt directed via a roller executing pivot motions, the corotron unit has a corotron and a corotron suspension, wherein the corotron provides a corotron shield and a corotron element (for example a wire corotron). In the printing operation, the corotron is arranged fixed relative to the roller so that the separation and the parallel bearing of the corotron element relative to the roller do not change in the pivot movement of the roller; and the corotron element thus follows the roller. The roller unit made up of roller and roller suspension and the corotron form a unit that jointly executes the pivot movements in the print operation.

In order to be able to pivot the corotron away from the roller unit or towards it, the pivot arrangement is provided that interacts with the corotron unit so that the corotron can be pivoted away from the roller unit so that the belt or the corotron element can be exchanged. Upon pivoting towards the roller unit, the corotron is directed so that it is again connected in a fixed manner with the roller unit.

To transport a belt (for example a transfer belt; not shown in the drawing Figures) a roller unit WE made up of a roller 1 and a roller suspension 2 is provided. The roller 1 is borne in the roller suspension 2 via an axle 3. The roller suspension 2 (and therefore the roller 1) can additionally be pivoted around the axle A1 transverse to the rotation direction of the roller 1. The roller 1 can be adapted to position changes of the belt via pivot movements around the axle A1.

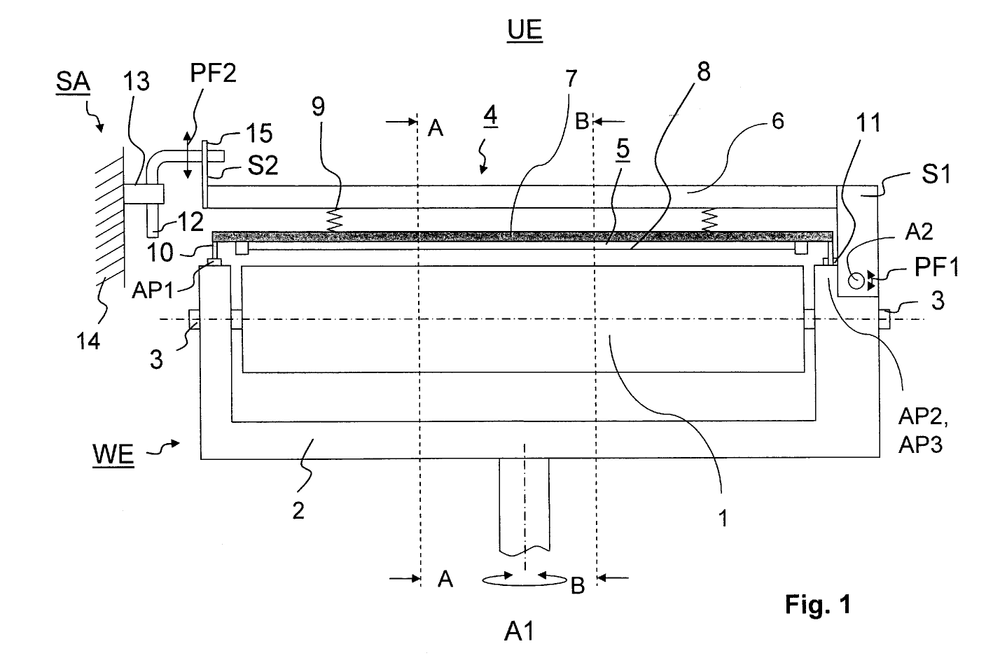

FIG. 1 shows a corotron device UE, for example for a transfer belt corresponding to US 2008/0205920 A1. Toner images on the belt can have their charges, reversed with the corotron device UE. The corotron device UE has a corotron unit 4 with a corotron 5 and a corotron suspension 6. The corotron 5 has a corotron shield 7 and a corotron element 8 (a wire corotron 8 in the drawing Figures, for example). The corotron 5 is attached to the corotron suspension 6 via springs 9. The corotron suspension 6 can be borne on one side S1 such that it can rotate on an axle A2 at the roller suspension 2; and the corotron suspension 6 is executed such that it can move freely on the other side S2.

The corotron device UE additionally has a pivot arrangement SA that is provided at the corotron suspension 6 at its side S2. The corotron unit 4 can be pivoted away from the roller unit WE or towards this with the pivot arrangement SA.

In order to keep the distance from wire corotron 8 to roller 1 constant, and additionally to always keep the wire corotron 8 parallel to the roller 1 (even given pivot movements of the roller unit WE around the axle A1), the corotron 5 is arranged fixed relative to the roller 1 so that the wire corotron 8 follows the pivot movements of the roller 1. In order to achieve this, the corotron shield 7 is supported by support points apparatus at the roller suspension 2. For example, the corotron shield 7 can be supported with one side on two support points AP2, AP3 on the roller suspension 2 (for example in a guide 11); on the other side the corotron shield 7 can have an alignment pin 10 that can engage in a bore 22 of the roller suspension 2 (support point AP1, FIG. 4). In order to facilitate the sliding of the alignment pin 10 into the bore 22, the bore 22 can have a guide surface executed with a slope along which the alignment pin 10 can slide before it engages in the bore 22 (and therefore establish the bearing of the corotron shield 7 at the roller suspension 2). The corotron shield 7 is additionally pressed onto the roller suspension 2 with the elastic force of the springs 9, such that the corotron 5 remains rigidly coupled to the roller suspension 2 and follows the movements of the roller suspension 2 even given pivot movements of the roller suspension 2 around the axle A1.

In order to be able to change the belt or the corotron wire 8, the corotron unit 4 can be pivoted away from the roller suspension 2. For this the corotron suspension 6 is borne on one side S1 with the axle A2 in the roller suspension 2 such that the corotron suspension 6 can pivot. The other side S2 of the corotron suspension 6 has the pivot arrangement SA with which the corotron suspension 6 and the corotron 5 can be pivoted on the axle A2. For print operation, the corotron 5 is pivoted towards the roller suspension 2; and at the end of the pivot movement the corotron suspension 6 meets the roller suspension 2 at the support points AP2, AP2, the alignment pin 10 engages in the bore 22 at the support point AP1 in the roller suspension 2, and the rigid connection with the roller suspension 2 is therefore established in which it is held by the springs 9. In a pause operation, the corotron unit 4 (and therefore the corotron 5) can be pivoted from the roller suspension 2 in the arrow direction PF1. For this the pivot arrangement SA is operated so that the corotron unit 4 is pivoted away from the roller suspension 2 on the axle A2. The corotron suspension 6 thereby carries along the corotron 5 by the springs 9 so that the corotron 5 is likewise pivoted away. An exchange of the corotron wire or a belt is then easily possible.

The pivot arrangement SA can be executed differently. For example, a lever arrangement can be used whose lever arm 12 is movable perpendicular to the roller suspension 2 (arrow PF2) and is borne with a first mount 13 at a housing plate 14. The lever 12 is furthermore directed optimally without friction in a second mount 15 that is attached to the corotron suspension 6. The second mount 15 provides for the lever 12 a slot (elongated hole) 16 with a running surface 17 for the lever 12 (FIG. 4). It is therefore ensured that pivot movements of the corotron suspension 6 cannot be transferred to the lever 12. The corotron unit 4 can thus move with the roller suspension 2. By shifting the lever 12, the corotron unit 4 can be pivoted around the axle A2.

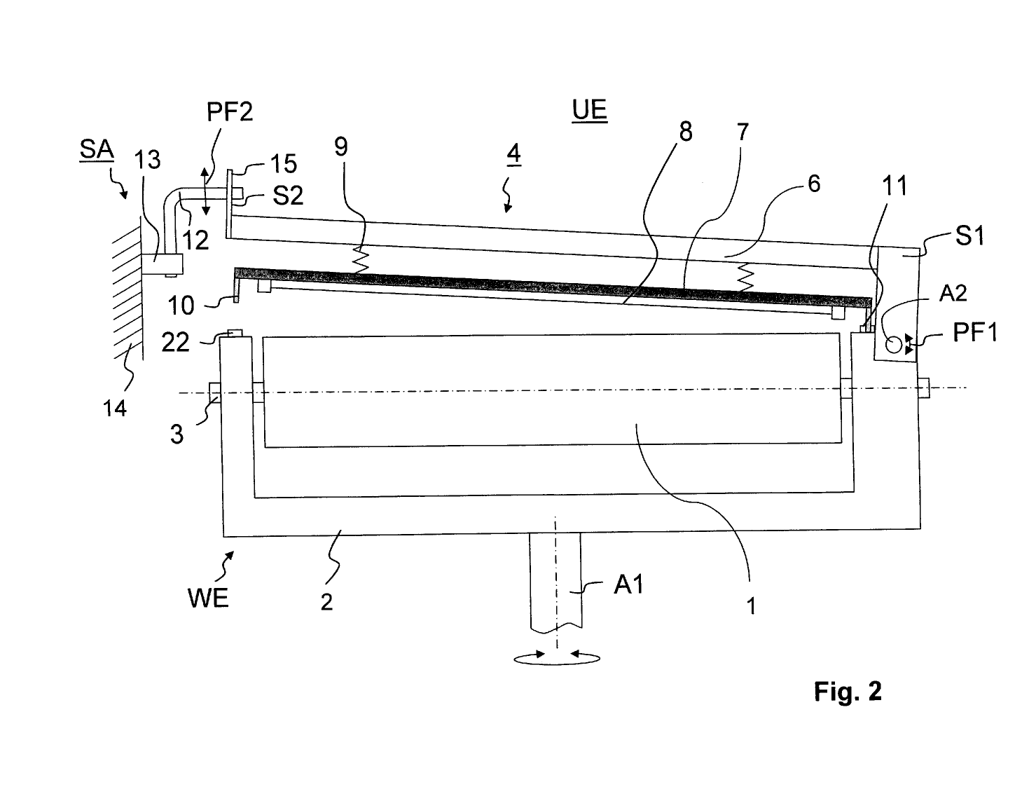

FIG. 2 shows the corotron unit 4 in the pivoted-away state. If the lever 12 is raised in the first mount 13, it carries along the second mount 15 at the corotron suspension 6; and the corotron unit 4 thereby pivots around the axle A2. The corotron wire 8 or the belt is now accessible and can be exchanged, for example.

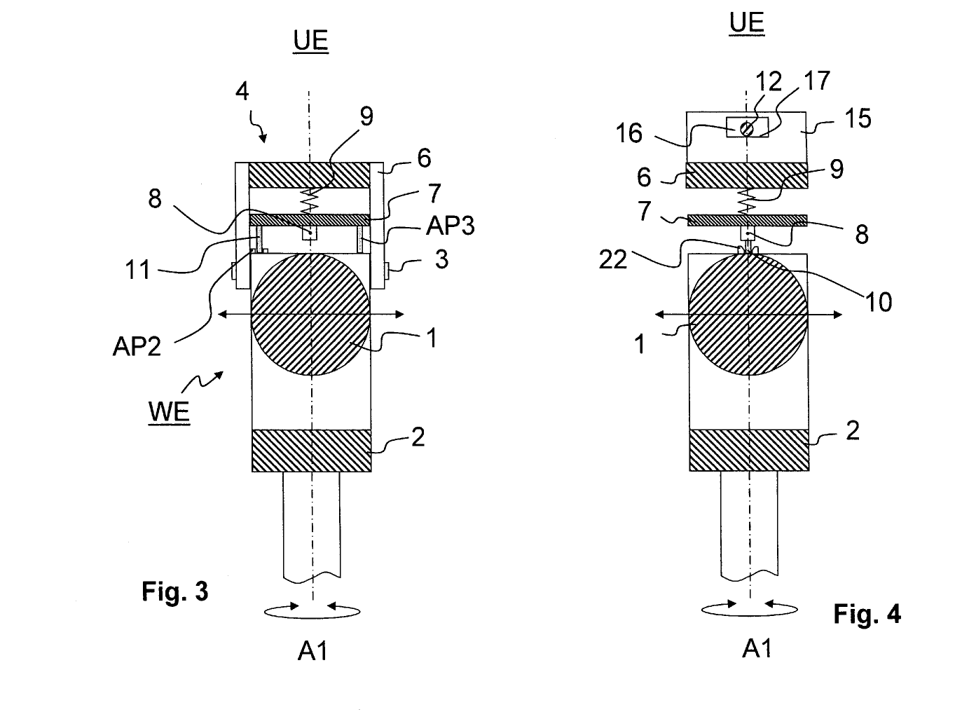

FIG. 3 shows a section through the corotron device UE and roller unit WE at the point A-A. The two support points AP2, AP3 are shown at which the corotron shield 7 is supported on the roller suspension 2. The corotron shield 7 is thereby engaged in the guide 11.

A section through the corotron device UE and the roller unit WE at the point B-B results from FIG. 4. In particular the second mount 15 for the lever 12 with the slot 16 is shown here. The lever 12 can thus slide back and forth on the running surface 17 in the slot 17 if the corotron suspension 6 moves with the roller unit WE; the lever 12 then does not move with this. The embodiment of the bore 22 and the coupling of the alignment pin 10 with the bore 22 can also be learned from FIG. 4.

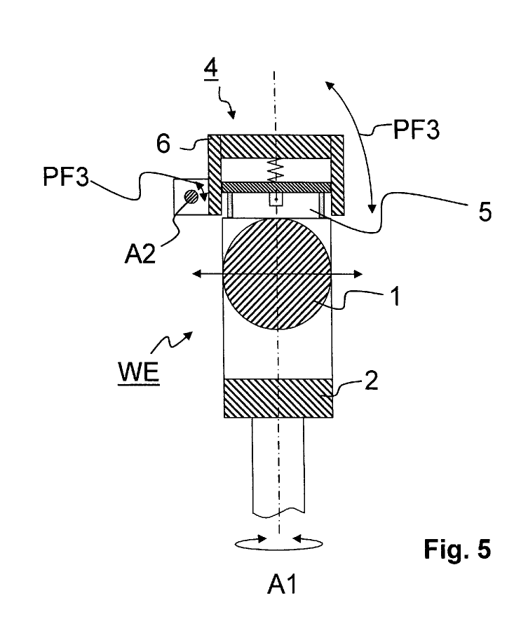

A second embodiment of the bearing of the corotron device 4 can be learned from FIG. 5. Here the axle A2 for the pivoting of the corotron unit 3 can be arranged laterally so that the corotron unit 4 can be tilted away from the roller unit WE in the arrow direction PF3.

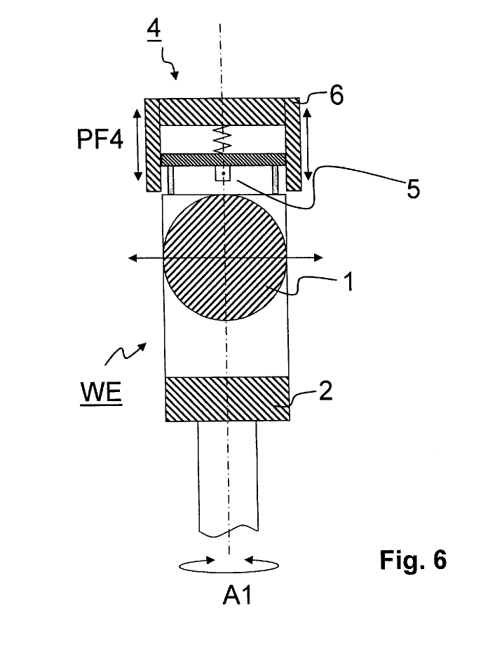

Finally, the corotron unit 4 can be borne such that it can be raised in parallel in the arrow direction PF4 by the roller suspension 2 or can be placed on the roller suspension 2 (FIG. 6).

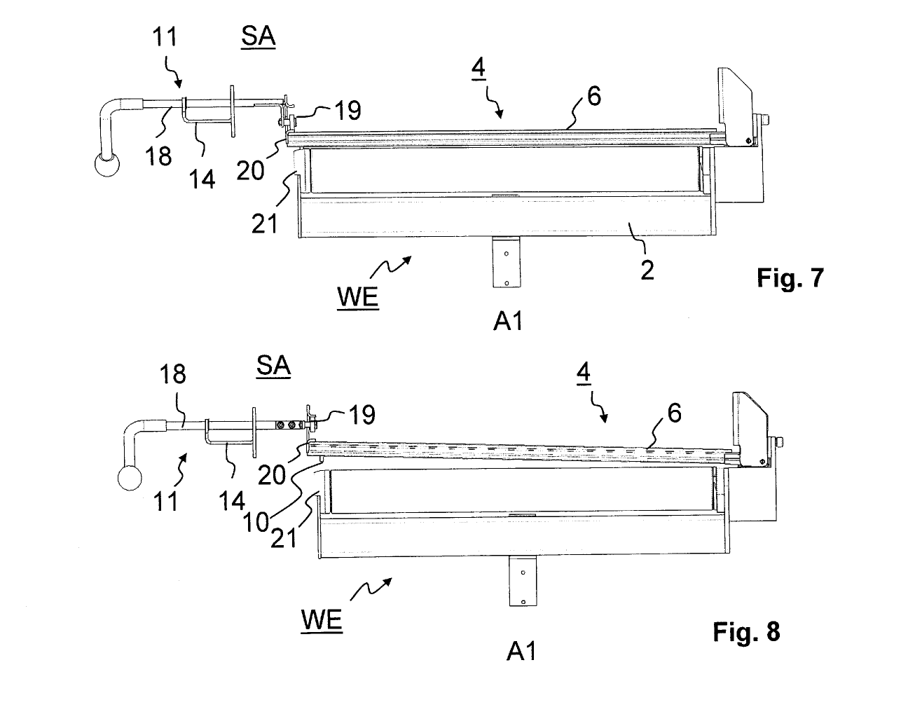

FIGS. 7 and 8 show a second embodiment of the pivot arrangement SA. Here swivel lever 18 is provided mounted on the housing plate 14, which swivel lever 18 has at its free end a ball bearing 19 that slides along a running surface 20 arranged at the corotron suspension 6 given the pivot motion of the roller unit WE. In the position of the swivel lever 18 according to FIG. 7, the ball bearing 19 is in its lower position, wherein the corotron suspension 6 rests on the roller suspension 2. By rotating the swivel lever 18 into the position of FIG. 8, the ball bearing 19 raises the corotron suspension 6, wherein the corotron unit 4 is pivoted away from the roller unit WE.

Upon pivoting the corotron unit 4 towards the roller unit WE, the alignment pin 10 engages in a flange 21 of the roller 1 and centers the corotron 5 relative to the roller 1.

The advantages of the preferred embodiments are apparent in the following points:
A variation of the distance between the corotron element 8 and the roller 1 during the printing is precluded by the corotron unit 4 supported on the roller suspension 2. The distance, which is set once, remains the same for all positions of the roller suspension 2 since the corotron 5 follows the movement of the roller 1.
The bearing of the corotron shield 7 can be determined in a self-centering manner by three support points AP given a pivoting corotron unit 4. For this reason a complicated and error-prone adjustment procedure for the corotron 5 is not necessary.
The pivot arrangement SA to be operated manually functions independent of the position of the roller 1.
In spite of the varying position of the roller 1, there is no effect on the control process for the roller 1 during the print operation due to the fixed position of the pivot arrangement SA.
The disassembly and installation of the corotron unit 4 are very service-friendly and simple to operate due to the suspended design.

While preferred embodiments have been illustrated and described in detail in the drawings and foregoing description, the same are to be considered as illustrative and not restrictive in character, it being understood that only the preferred embodiments have been shown and described and that all changes and modifications that come within the spirit of the invention both now or in the future are desired to be protected.

1. A corotron device system, comprising:
a moving element moving via a guide unit;
a corotron having a corotron element and a corotron shield; and
the corotron element arranged relative to the moving element such that a distance from, and a parallel position of, the corotron element relative to the moving element do not substantially change.

2. The corotron device according to claim 1 in which the guide unit for the moving element is borne in a guide unit suspension, the corotron is supported on at least three support points at the guide unit suspension, and wherein the corotron is designed at least at one support point such that there it engages in the guide unit suspension.

3. The corotron device according to claim 2 in which the corotron shield of the corotron is supported with one side surface at the guide unit suspension, and the corotron shield of the corotron has at least one alignment pin on another side surface, said alignment pin being engaged in a bore of the guide unit suspension, said bore being designed as a guide surface.

4. The corotron device according to claim 1 in which a corotron suspension is provided at which the corotron shield of the corotron element is attached via springs, and wherein the springs exert an elastic force on the corotron shield in a direction towards the guide unit.

5. The corotron device according to claim 4 in which the corotron suspension is borne at one end such that it can pivot on the guide unit suspension, and in which the corotron suspension is borne at another end at a pivot arrangement such that the corotron is pivoted towards or away from the guide unit suspension under elastic force.

6. The corotron device according to claim 5 in which the pivot arrangement provides a lever borne such that it can be displaced at a housing surface, said lever being arranged such that it can be displaced perpendicular to the guide unit.

7. The corotron device according to claim 6 in which the corotron suspension has a slot aligned in a pivot direction of the guide unit, in said slot a lever engaging so that the guide unit suspension and the corotron suspension with the corotron can still pivot when said lever is stationary.

8. The corotron device according to claim 5 in which the pivot arrangement has a swivel lever at one end of which is provided a ball bearing, the ball bearing interacting with a running surface of the corotron suspension such that in one position of the swivel lever, the corotron suspension with the corotron is raised from the guide unit suspension, and in another position of the swivel lever said corotron suspension with the corotron is pressed against the guide unit suspension such that the alignment pin is engaged in the bore.

9. The corotron device according to claim 2 in which the corotron unit can be pivoted on a pivot axis that is arranged on the longitudinal side of the guide unit suspension.

10. The corotron device according to claim 2 in which the corotron unit is arranged perpendicularly above the guide unit suspension such that it can pivot away.

11. The corotron device according to claim 1 in which the corotron element comprises a wire corotron.

12. The corotron device according to claim 1 in which the guide unit comprises a roller.

13. An electrographic printing apparatus corotron device system, comprising:
a moving transfer belt moving via a guide unit, said transfer belt having toner images thereon;
a corotron having a corotron element in a corotron shield, said corotron element reversing a charge of said toner images on said transfer belt; and
the corotron element arranged relative to the moving element such that a distance from, and a parallel position of, the corotron element relative to the moving element do not substantially change.

14-16. (canceled)

17. A corotron device system, comprising:
a transfer belt with toner images and a guide roller having said transfer belt passing thereover, a longitudinal axis of said guide roller partially rotating about an axis perpendicular to said longitudinal axis;
a corotron having a corotron element and a corotron shield; and
the corotron element being arranged relative to the transfer belt such that a distance of the corotron element from the transfer belt does not substantially change, and a parallel position of a longitudinal extent of the corotron element relative to said longitudinal rotational axis of said roller does not substantially change.

18. A system of claim 17 wherein the guide roller for the transfer belt is borne in a guide unit suspension and the corotron is supported on at least three support points at the guide unit suspension.
